(19) United States
(12) Patent Application Publication
(10) Pub. No.: US 2007/0143126 A1
(43) Pub. Date: Jun. 21, 2007

(54) Method and system to determine a desirable diet

(76) Inventor: Anjan Ghose, Palo Alto, CA (US)

Correspondence Address: Anjan Ghose, 4119 Park Blvd, Palo Alto, CA, 94306, US

(21) Appl. No.: 11/304,385

(22) Filed: Dec. 15, 2005

(51) Int. Cl. G06Q 99/00

(52) U.S. Cl. 705/1

(57) ABSTRACT

A method and system of determining a desirable diet based on mathematical programming algorithms is disclosed. A user is presented with a list of diet items whose nutrient breakdown have been stored on a computer. The user selects the items he wishes to eat, along with a preference ranking, and also enters nutrition requirements that he wishes to adhere to. The user may also enter his own recipes to the system for use in building his diet. The computer solves the problem using well known techniques and presents results to the user, who may edit parameters to get a more ‘preferred’ diet. The process may be interactive until user ceases the interaction.

### CROSS REFERENCE TO RELATED APPLICATIONS

N/A

### FEDERALLY SPONSORED RESEARCH

N/A

### SEQUENCE LISTING OR PROGRAM

N/A

### BACKGROUND OF THE INVENTION

1. Field of Invention

This invention relates to an interactive diet selection process, that satisfies nutritional requirements and user preferences.

2. Prior Art

Previously there has existed in mathematical programming literature a reference to the ‘diet problem’. The diet problem is often used in basic Operations Research textbooks to showcase a typical application of the types of problem that classical mathematical programming methods can solve. The problem has been described in the literature since the birth of the field of Operations Research in the 1940s.

The goal of the diet problem is to find the cheapest combination of foods that will satisfy the daily nutritional requirements of a human. A nutrient is a chemical element or a compound present in food items that affects the user's health or energy intake. Common examples of nutrients in foods are fats, carbohydrates, proteins, salt, cholesterol, sugar and vitamins. The problem is formulated as a linear program where the objective is to minimize cost and meet constraints which require that nutritional needs be satisfied. Typical constraints are ones that regulate the number of calories and amounts of vitamins, minerals, fats, sodium and cholesterol in the diet. The diet problem is sometimes also formulated as a mixed linear integer programming problem (MILP), where additional constraints specify whether one or more variables in the problem is restricted to be integral.

There are numerous references to the diet problem in the literature. An internet search of pages containing all of Mathematical Programming Diet Problem words within each page returned 132,000 results¹. While a significant number of results refer to educational coursework description, it is nevertheless well described outside of the educational framework, as evidenced by 54,000 results found only on “.com” type of domains. The fundamental diet problem, which we shall henceforth refer to as the Standard Diet Problem (SDP) has remained unchanged in the literature for the past half century.
¹ Yahoo search Nov. 10, 2005

The foundations of linear programming is well documented in the literature. Problems formulated as such programs contain (a) a set of variables representing the decision variables of the problem (b) at least one objective function, which is a linear combination of decision variables, that is to be maximized or minimized and (c) a set of constraints, represented using decision variables, that needs to be satisfied While optimizing the objective function.

There are numerous textbooks explaining the fundamentals of linear and integer programming, at various levels of depth. For a non-technical introduction to linear programming, we refer to An Illustrated Guide to Linear Programming by Saul Gass, Dover Publications 1990. For a more rigorous treatment of the subject, we refer to Linear Programming: Methods and Applications 5^{th} Edition by Saul Gass, Dover Publications 2003. For a comprehensive treatment of integer programming, the reader is referred to Integer Programming by Lawrence Woolsey, Wiley InterScience, 1998.

A formulation of the SDP in terms of linear programming terminology is presented below.

Assume that a user wishes to restrict his daily fat, sugar and calorie intake amounts within certain limitations (say F, S and K), but wishes to exceed a minimum protein and vitamin A intake (say P and V). He wishes to eat n items in his daily diet (with quantity of say x₁ through xₙ). The values of x₁ through xₙ are unknown and will be solved by linear programming techniques. The cost of items 1 through n are (say) c₁ through cₙ. Also assume that the amounts of fat, protein, sugar, vitamin and calories in a unit quantity in each of the n items are known, (say) f₁ through fₙ, p₁ through pₙ, s₁ through sₙ, v₁ through vₙ, and k₁ through kₙ. Then the diet problem is formulated as minimizing the cost of food items, subject to satisfying the user's constraints. Mathematically,

Minimize the objective function:
c₁*x₁+c₂*x₂+ . . . +cₙ*xₙ
Subject to the constraints:
f₁*x₁+f₂*x₂+ . . . +fₙ*xₙ<F
s₁*x₁+s₂*x₂+ . . . +sₙ*xₙ<S
k₁*x₁+k₂*x₂+ . . . +kₙ*xₙ<K
p₁*x₁+p₂*x₂+ . . . +pₙ*xₙ>P
v₁*x₁+v₂*x₂+ . . . +vₙ*xₙ>V
x₁, x₂, . . . xₙ>=0

The problem formulated above may be solved by multiple techniques, described in the references named above. Note that the above problem is just a typical example, in real life the actual constraints selected will vary considerably depending on the user's wishes. In addition, there may be other constraints, such as the user wishing the limit the consumption amount of item i to Ai(say), or would like to eat a minimum amount Aj of item j (say). The following two constraints are then added to the above constraint set.
x₁<=Aᵢ
xⱼ>=Aⱼ

Sometimes it is not possible to find a feasible solution based on the data. In such cases, the techniques to solve such problems would indicate the infeasibility. The case is similar for problems that may be unbounded, whereby the objective function can be infinite without any constraint limiting it. Usually, if the data is accurate, and the user's wishes are rational, the SDP has a feasible optimal solution.

Though not often quoted in literature, the diet problem may also have restrictions on whether a variable is an integer. For example, a user may wish to eat a whole item or a multiple during a meal. This problem can then become a mixed integer linear programming problem (MILP) where there exists the additional restrictions that certain variables is limited to be integral only.

The above problem can be meaningfully solved only if there exists data on the breakdown of nutrients of each selected item for a unit weight of the item. The calorie value of the food item, for a unit weight of the item, must also be known. A number of agencies and corporations, both in the United States and abroad, have performed and published these figures in publicly available databases. Two well known examples are the Nutritional Analysis Tool (NAT) database developed at the Department of Food Science and Human Nutrition at the University of Illinois, and the United States Department of Agriculture National Nutrient Database for Standard Reference.

There exists different methods to solve linear programming problems. The most well known method of solving linear programming problems is the Simplex method invented by George Dantzig in 1947. A complementary theory named duality theory that helps solve certain linear programming problems in an easier manner, was invented by John Von Neumann in 1947. In 1979, Leonid Khaciyan presented the ellipsoid method, guaranteed to solve any linear program in a number of steps which is a polynomial function of the amount of data defining the linear program. Consequently, the ellipsoid method is faster than the simplex method in contrived cases where the simplex method performs poorly. In 1984, Narendra Karmarkar introduced an interior-point method for linear programming, combining the desirable theoretical properties of the ellipsoid method and practical advantages of the simplex method.

Methods to solve integer programming problems include the Cutting Plane method invented by Ralph Gomory in 1957, and the Branch and Bound method invented by Land and Doig in 1966. The theories of these methods are explained in detail in many textbooks on the subject including the references mentioned above.

Linear programming problems can often also be solved by formulating an alternative problem and solving the alternative problem. This technique is well described in literature as solving the ‘dual’ problem.

The implementation of these methods require the use of a digital computer, for all but the very smallest of problems. There are several software packages that implements the methods described above, many available for free as open source software. A list describing available linear programming packages can be found from the Argonne National Laboratory website at http://www-fp.mcs.anl.gov/otc/Guide/SoftwareGuide/Categories/linearprog.html and a list describing available integer programming packages can be found from the same website at http://www-fp.mcs.ani.gov/otc/Guide/SoftwareGuide/Categories/intiprog.html.

The diet problem as explained above, can be implemented using any software that can handle medium sized MILP problems, such as the ones listed in the URL links above. The implementor would use a computer language to formulate the MILP program in a manner understandable to the machine.

Over the years, the SDP has had the drawback of being further and further disconnected from a real-world case. As described above, the objective function of the SDP has traditionally been to find the least cost diet that satisfied nutritional constraints. The historical reason behind such an objective was that food was a significant cost item as a percentage of family income fifty years ago. In the past half century, the standard of living has risen all over the world, and for middle-class families in advanced countries, in particular, the cost of the food is no longer a significant factor while determining what to eat. A more relevant formulation and solution of the diet problem is required and should be available to all citizens concerned about their diet based on the citizen's preference. My invention overcomes the above mentioned drawback and achieves this goal.

In addition, the diet problem and its solution can be of use to any person who wishes to analyze his or her diet. The internet is an ideal medium to allow ubiqitious access to a user wishing to formulate his own food item selection, his relative preference of these items, pre-loading the server computer with nutrient data for these items, and iteratively allowing the user to proceed to a desired solution. My method allows users to achieve this goal.

Sites catering to dieting needs of consumers that allow user interaction over the internet are numerous. A few well-known ones are E-Diets (http://www.ediets.com) of Deerfield Beach, Fla., NutriSystem, Inc (http://www.nutrisystem.com) of Horsham, Pa. and DietWatch (http://www.dietwatch.com) of East Rockaway, N.Y. These sites and all others that I know of suffer from a big disadvantage: the user does not have full freedom to select the food items that he wishes to eat. Usually, the sites categorize a ‘dieting system’ and the user is able to select from a sub-set of food items within the system. Popular dieting systems include: South Beach Diet, Atkins Diet, Mediterranean Diet and Glycemic Impact Diet. In some cases, diet systems are tailored for specific health conditions; for example E-Diets offer High Fiber Plan Diet, Low Sodium Plan Diet and Living with Diabetes Plan Diet. None of the diet systems, however, allow the user full freedom of selecting from a full set of food items without restrictions. My method of determining the desired diet overcomes this disadvantage.

A number of patents have been awarded for measuring compliance of a diet or weight-loss system against stated goals and/or behavior patterns. U.S. Pat. No. 6,336,136 to Harris (1999) discloses an internet-based, weight reduction expert system that is used to determine the proper course of action for a dieter. The system advises on behavior changes required to attain the user's weight reduction goals. U.S. Pat. No. 6,083,006 to Coffman (2000) discloses a personalized nutrition planning system. The user answers a detailed questionnaire in order for the system to determine a daily calorie intake, and recommends preferred nutrients with a created menu to satisfy the calorie intake requirements. U.S. Pat. No. 5,412,560 to Dennison (1995) that provides a process for evaluation of an individual's food choices based upon selected factors and dietary guidelines is disclosed. The invention analyzes the food an individual eats and determines certain predictor and follower nutrients that will give rise to an assessment of how a person's diet matches with various dietary guidelines established by governmental and/or other entities. The invention also gives individuals a “score”, the higher the score, the better the diet. U.S. Pat. No. 5,673,691 to Abrams, et al. (1997) discloses an apparatus to control diet and weight using human behavior modification techniques. In the preferred embodiment, a hand-held computer prepares and monitors a goal-oriented weight, nutrition and exercise control program. Visual and audio prompts tell users when to eat and exercise, and provide suggestions for what to eat. The computer assists the user in setting safe goals for desired weight loss and the time required to achieve the loss.

A number of patents have been awarded for accurate measurement of dietary consumption. U.S. Pat. No. 5,412,564 to Ecer (1995) discloses a system and method for diet control. The consumer is required to carry a smart card which is inserted into a card reader-writer before purchase transactions. The system allows recording and monitoring of dietary consumption by registering the nutrition in each food purchased via the bar code label. U.S. Pat. No. 5,233,520 to Kretsch et. al (1993) discloses an interactive computerized dietary measurement system and process which can be used by lay people for accurate measurement of the intake of foods, nutrients, and other food components in the diet. U.S. Pat. No. 5,839,901 to Karkanen (1998) discloses an integrated weight loss control method. This is an integrated system of collecting data and reporting results, enabling an understanding of weight control and weight loss. The primary object of this invention is to provide the individual with a simple to use weight loss management tool to control weight loss more accurately and flexibly. U.S. Pat. No. 4,796,182 to Duboff (1989) discloses an electronic device for displaying preset amounts of food categories allowable in a daily diet, for permitting a digital entry representative of food consumed, and for subtracting that entry from the preset amount and displaying the result.

The above patents does not deal with interactively building a diet while satisfying nutritional requirements.

A number of patents have been awarded for predicting a ‘correct’ diet by some measurement of a patient's general health. U.S. Pat. No. 6,190,313 to Hinkle (2001) discloses a system to remotely monitor the health of a patient using statistical control techniques on the patient's physiological parameters, determined by one or more sensors on the patient. U.S. Pat. No. 5,937,387 to Summerell, et al. (1999) discloses a system and method for developing a customized wellness plan for measuring a user's wellness by determining a user's physiological age. The system and method also help a user to learn about personalized wellness options, where the wellness options have been chosen for the user based upon wellness factors input by the user, additional constraints input by the user and the most recently available information relating to the health sciences. The user can select one or more options, and determine the potential effect implementing the options could have on the user's physiological age over the short or long term. U.S. Pat. No. 4,951,197 to Mellinger (1990) discloses a weight loss management system utilizes a computer analysis of a participant's past medical history, eating habits, body measurements, exercise level and taste preferences to provide a menu of a specified number of calories to maintain a reasonable weight. The system provides consultation with a dietitian in order for a participant to recognize the deficiencies in the past diet.

The above patents cater to determining a diet based on a health measurement index, but does not address diet item selection based on user wishes and nutritional requirements.

A few patents have also been awarded for methods to improve meals with nutritional supplements or including certain food groups. U.S. Pat. No. 5,954,640 to Szabo (1999) discloses a Nutritional Optimization Method which employs a health model based on personal diet and health information to recommend at least two nutritional supplements to the user. Economic considerations i.e budget is accounted for during the recommendation process. U.S. Pat. No. 4,954,954 to Maden, et al. (1990) discloses relates to a method and apparatus for preparing a series of daily menus that include foods having preselected characteristics. The menus are prepared from a list containing numerous food items, the caloric content of each item, which food group each item resides, and the applicability of each item for a particular meal. Replacement food items of similar calorific characteristics is recommended by the system.

None of the above patents attempt to solve the general problem of the average dieter: creating a diet that allows him to eat all his favorite items, perhaps add some other items recommended by his physician in limited quantities, and get a system to recommend him the maximum preference weighted amounts of these items he can eat without violating his chosen nutritional requirements. Selection of a desirable diet should be an iterative process, where the dieter uses a give-and-take approach of what food items to include, eliminate and in what quantity. None of the above patents address the iterative nature of the issue by using an interactive approach to determining the most desirable diet.

There is a need to allow a prospective dieter to choose a set of food items without restriction, based on his tastes. He needs to be able to select dietary guidelines quickly and easily, while interacting with a computer, to determine the maximum quantities of his selected items he may consume while still meeting the dietary guidelines. Finally, the process must be ubiquitous, available to the user from remote locations, and must rely on rigorous fundamental techniques to arrive at the solution. Our method achieves all these goals.

### OBJECTS AND ADVANTAGES

As explained above, the objective function of the SDP is to minimize the overall cost of food items within the diet. My modified objective function is to maximize the preference weighted amounts of food items chosen by the user. Note that we are trying to maximize the user's satisfaction of being able to eat the maximum amount of the food he enjoys. For example, for a meat loving user who has to tolerate broccoli on his doctor's orders, he could assign a weight of (say) 5 to a cheeseburger (quantity variable x₁) and lower weight 1 (say) to broccoli (quantity variable x₂). In this two item contrived example, the weighted objective function would be represented as “Max 5*x₁+x₂”. In the simplest case of the user weighing each item equally, the objective function equals maximizing the amount of food intake.

Therefore, my method improves the classical diet problem by changing the objective function to maximize the weighted average of user preferences, rather than minimize the overall cost of the food items. My proposed modification of the diet problem will henceforth referred to as Preference Diet Problem (PDP). Therefore the PDP is an MILP with a preference weighted objective function, which I shall refer to as Preference Function (PF).

The PDP can be solved on a digital computer with only a change in the formulation of the problem, but no change in any algorithm being used to solve the MILP. My method allows a user to solve the PF/MILP on a computer in an interactive manner, whereby several model parameters can be edited by the user until either the user stops at a solution or the problem is found to be infeasible, or the problem is found to be unbounded. My method also allows the computer to use the dual formulation of the same problem to solve the PDP, if the dual problem is easier to solve computationally.

My method allows the user to select any food item from a list of items whose nutrient data has been pre-analyzed and stored in a database on the web server computer. Unlike other diet methods, there is no limit to the choice of food items that is being offered to the user. In addition, my method allows a user to input his or her own dishes whose nutrient data will be analyzed by the computer system and stored in a database.

Further objects and advantages of my invention will become apparent from a consideration of the drawings and ensuing description.

### SUMMARY

In accordance with my invention, a method of formulating and implementing a diet selection process is described. The method comprises steps of: the user selecting a set of input parameters comprising food items, optional recipe items to the database, optional desired minimum or maximum amounts, and desired nutritional requirements as an input to a computer, the system solving the PDP described above and presenting the solution in tabular and/or graphical form to the user, the user being allowed to modify the input parameters, the computer resolving the diet problem with the new input and presenting results to the user iteratively, until the user ceases the interaction or the computer determines an infeasible or an unbounded solution.

In one embodiment of my invention, the computer is a web server and the interaction with the user occurs over a web browser, with the internet as the medium. In an alternative embodiment of my invention, the computer is a general purpose computer with my invention programmed in software, and installed on the computer from a CD or other storage disk.

### DRAWINGS—FIGURES

FIG. 1 is a block diagram of the claimed method representing one user interacting with one web server.

FIG. 2 is a flow diagram of the information passed between the user and the system while implementing the PDP method.

### DETAILED DESCRIPTION—PREFERRED EMBODIMENT

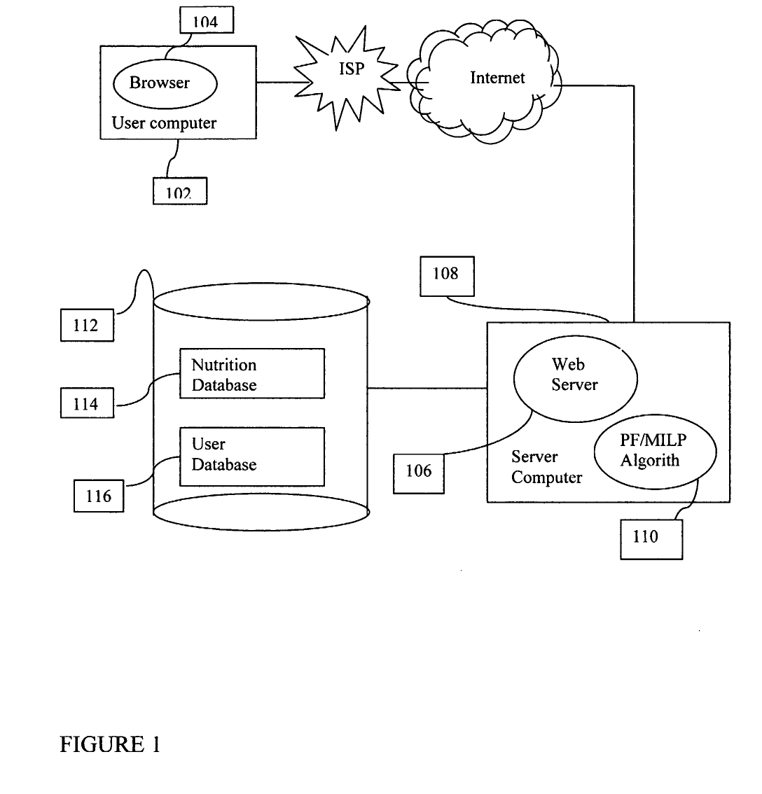

The preferred embodiment of the present invention is illustrated in FIG. 1.

A user using a web browser 104 on a computer 102 requests the use of the invented method over a web site. The request is transferred via the user's Internet Service Provider (ISP) over the Internet to a web server 106 running on a server computer 108. The web server displays the top page of the web site back to the user. The user enters the food items from a list presented on his browser, along with the calorie and nutrient requirements. Nutrient requirements may be specified using (a) percentage of total calories that are obtained from each nutrient over the diet period or (b) the total amount of nutrient that is to be consumed over the diet period. Typical diet periods include daily or weekly diets. The total calories are either specified by the user over the diet period based on pre-existing information, or the system calculates a recommended total calories based on user input of his physical and lifestyle characteristics. The user can accept the recommendation as is, or he may choose to use it as a guideline for his inputs.

As an example, the system can recommend a suitable daily calorie amount based on the user's age, weight, height, diet goals, and typical daily physical activity information. For example, a young man with a vigorous, physical lifestyle would be recommended a higher calorie value for a healthy lifestyle, compared to a sedentary individual. For a user wishing to lose weight, the system would recommend a calorie value that would conform to the user's goals without adversely affecting his health. For example, the user can further request that the calories from fats should not exceed 30% of his calories over the diet period, and furthermore that calories from saturated fats should not exceed 10% of his total calorie intake. Such percentage values are left up to the user, but guidelines recommended by government agencies are well known, and may be used to guide the reader towards a desired value. In the United States, the most well known such guideline is the Dietary Guidelines for Americans is published jointly every 5 years by the Department of Health and Human Services (HHS) and the Department of Agriculture (USDA). Some nutrients are recommended in absolute quantities, and the user may be asked to select a certain weight of this nutrient to be consumed over the diet period. For example, the USDA recommends that intake of cholesterol be limited to less than 300 mg (milligrams) over any 24 hour period.

The user can also optionally select a ranking on the items selected. For example, on a scale of 1 through 10, assume that 10 is the food that the user prefers most, and 1 the least. The user can assign rankings to his chosen food items so as to ‘maximize’ his preferences. This is described as the Preference Function above. The default Preference Function is to assign equal weightings to all food items.

The user sends the data entered into his browser to the web server. The web server gathers the user data and passes the data to a software program that formulates and solves the PDP 110. The program uses nutrient data for food items stored in a nutrient database 114 on persistent storage 112. Nutrient data for thousands of food items is publicly available from a number of sources, and such data is pre-populated in a nutrient database on the web server. A user is also allowed is enter his or her own favorite recipes into a screen, and the program calculates the nutrient breakdown of the entered recipe, and adds the item to a secondary user database 116, consisting of user recipes. The program can then use items from both the nutrient database and the user recipe database as selections for diet item candidates.

If the program determines a feasible solution, then the solution is represented in graphical or tabular form and sent back to the user for display on the browser. If the problem is found to be infeasible or unbounded, the result is sent back to the user along with the input parameters. The user can edit the input parameters to attempt to reach a feasible solution.

Assuming a feasible solution is found, the user is presented with the solution. The user can then change parameters and send the data back to the web server computer for a different solution. The iterations continue until the user ceases editing parameters, or the computer reaches an infeasible or unbounded solution.

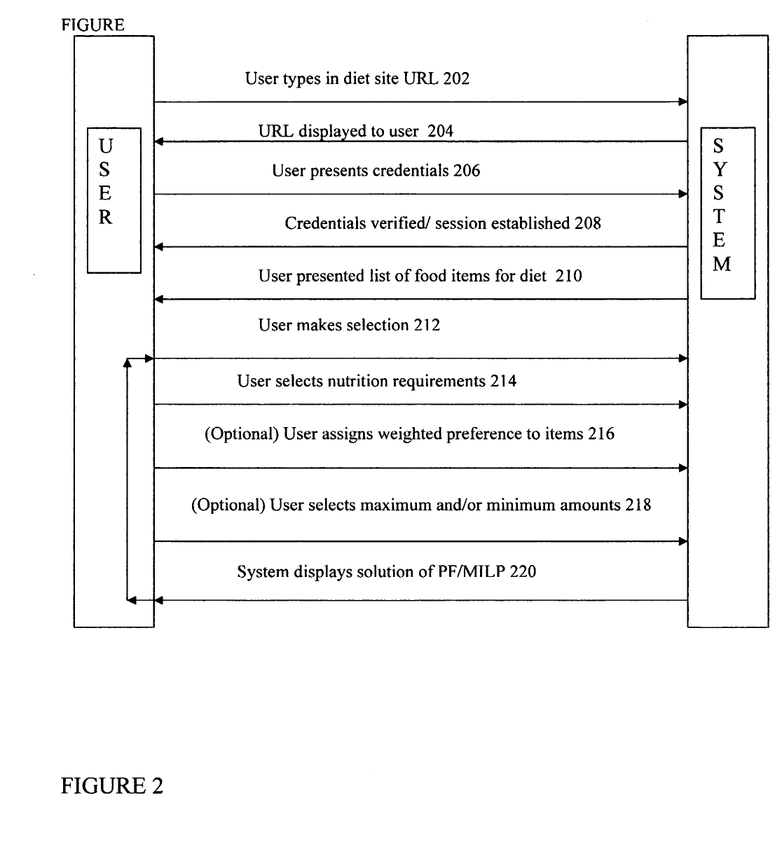

An alternative embodiment is for the method running on application servers in a clustered environment. This is necessary to handle the load of multiple users trying to determine their diet at the same time using the said method. The clustering mechanism effectively makes a network of computers act as a single large computer. Another embodiment can use a load balancing machine set up in front of a pool of web servers to divert user requests to one server in the pool. The basic data flows back and forth remains essentially unaltered, and will be examined in depth in FIG. 2.

Yet another alternative embodiment is for the method to run on a general purpose computer, with the data and the software program implementing the PDP on disk storage.

FIG. 2 represents the data flow during the interaction between the user and the server computer implementing the invented method.

In the first step, the user working on a conventional web browser types in the URL of the web site implementing the method 202. There is no restriction on either the browser type or the machine type on which the browser is running.

The URL is directed to the web site and the top level site page is displayed in the browser 204. The top level page has a form that the user can use to log into the system, in addition to having other display information. Other information includes instructions for registering for the service as a first time user.

The user enters his login credentials and submits the data, perhaps over an encrypted session, to the web server for validation 206.

If the user is validated, the user is presented with a display of food items from which the user can select a menu of items 210. The items may be displayed at the top level or can be grouped into sets of items, with the user required to choose a desired group. For example, a user wishing to choose a Chinese menu diet, may need to select the Chinese group before the entire food items available for selection is displayed.

The user can also select nutrient requirements or accept the default nutrient requirements 214.

The user may optionally enter the ranking of each food item in terms of desirability 216 in order to create the Preference Function. If he does not, the default PF is selected by the system. The default PF assigns equal weights to all food items in the selection.

The user may optionally enter the maximum and/or minimum amount of each food item whose quantity he wishes to limit. If he does not, the system assumes a reasonable default value that can be modified by the user, if desired.

The system solves the PDP according to the input data provided and presents the results to the user, either in tabular or graphical form 220.

Steps 212 through 220 of FIG. 2 may be repeated in an iterative manner if requested by the user, during the same session, or saved to be continued at a later session.

1-20. (canceled)

21. A method for determining a desirable diet for human consumption, performed by a computer user, comprising the steps of (a) selecting food items (b) accessing nutrient content information of said selected items (c) selecting consumption requirements or limits for one or more nutrients and (d) solving a mathematical program on a computer that determines the amount of each selected item and each nutrient consumed such that the solution substantially maximizes the total amount of food, while satisfying said requirements or limits.

22. The method of claim 21 wherein said mathematical program is a Linear Program.

23. The method of claim 21 wherein said mathematical program is a Mixed Integer Linear Program.

24. The method of claim 21 further comprising the step of a maximum amount to be consumed for any said selected item.

25. The method of claim 21 further comprising the step of a minimum amount to be consumed for any said selected item.

26. The method of claim 21 further comprising the step of a maximum total amount to be consumed for all said selected items.

27. The method of claim 21 wherein data communications between said user and said computer occurs over the internet.

28. The method of claim 21 wherein interaction between said computer and said user is iterative, with one or more said steps being repeated.

29. The method of claim 21 further comprising assigning relative weighted preference to one or more said selected items, and the solution substantially maximizes the total weighted preference of foods.

30. A computer system for determining a desirable diet for a human user, said system comprising of a database and software: (a) said database comprising a plurality of food items and nutrient content information of said food items; consumption requirements or limits for one or more said nutrients for each said user; (b) software that solves a mathematical program that substantially maximizes the total amount of food that can be consumed while satisfying said nutrient requirements or limits.

31. The system of claim 30 wherein said mathematical program is a Mixed Integer Linear Program.

32. The system of claim 30 wherein said mathematical program is a Linear Program.

33. The system of claim 30 further comprising said database storing a maximum amount of food to be consumed for any said selected food item.

34. The system of claim 30 further comprising said database storing a minimum amount of food to be consumed for any said selected food item.

35. The system of claim 30 further comprising said database storing a maximum total amount of food to be consumed for all selected food items.

36. The system of claim 30 wherein data communications between said computer system and said human user occurs over the internet.

37. The system of claim 30 wherein interaction between said user and said system is iterative, with said user changing one or more parameters of said database, and using said software to obtain a new solution.

38. The system of claim 30 further comprising the database containing data on relative weighted preference of one or more said food items for said human user, and the solution substantially maximizes the total weighted preference of food.
